(19) United States
(12) Patent Application Publication
(10) Pub. No.: US 2004/0091713 A1
(43) Pub. Date: May 13, 2004

(54) Adherable fluorine-containing material sheet, adhesive fluorine-containing material sheet, and adhering method and adhesion structure of fluorine-containing material sheet

(76) Inventors: Toshihiro Suwa, Sagamihara-city Kanagawa (JP); Keizo Yamanaka, Tokyo (JP)

Correspondence Address: 3M INNOVATIVE PROPERTIES COMPANY, PO BOX 33427, ST. PAUL, MN, 55133-3427, US

(21) Appl. No.: 10/258,937

(22) PCT Filed: Jun. 7, 2001
(86) PCT No.: PCT/US01/18344

(30) Foreign Application Priority Data
Jun. 9, 2000 (JP) 2000-179397

(51) Int. Cl. B32B 27/00; C09J 7/00

(52) U.S. Cl. 428/421; 428/422

(57) ABSTRACT

The present invention provides an adherable fluorine-containing material sheet, an adhesive fluorine-containing material sheet, an adhering method of a fluorine-containing material sheet, and an adhesion structure. In one aspect, on the surface of an electron beam non-degradable fluorine-containing material, an adherability-imparting layer is provided, between which a chemical bond is formed by electron beam irradiation.

### TECHNICAL FIELD

The present invention relates to an adherable fluorine-containing material sheet, an adhesive fluorine-containing material sheet, an adhering method of a fluorine-containing material sheet, and an adhesion structure.

### BACKGROUND ART

Fluorine-containing materials such as Dyneon™ THV (terpolymer of tetrafluoroethylene, hexafluoropropylene and vinylidene fluoride, produced by Dyneon) and PVDF (polyvinylidene fluoride) have excellent properties which hydrocarbon-based material cannot possess, and occupy a very important position in industry. For example, the fluorine-containing materials are suitable as a surface protective material of a billboard, a reflector, a solar cell or the like, particularly for outdoor uses, because of their specific properties such as good chemical stability, excellent weatherability and high thermal stability.

The fluorine-containing material may be used solely as a part by inserting it or fixing it with screws or the like, however, the fluorine-containing material is generally expensive and therefore, mostly used as a composite material improved in the function by combining it with other materials (lamination or covering). These composite materials are expected of uses, for example, a substitute film for finish coating or a protective film of billboards.

However, the fluorine-containing material inherently has a low surface energy, therefore, suffers from extremely poor adhesion to a dissimilar material, for example, an adhesive or a pressure sensitive adhesive. To overcome this problem, various methods have been heretofore investigated for improving the adhesive property.

These methods are roughly classified into 1) a method of modifying the fluorine-containing material deficient in the adhesive property to enable its adhesion to an existing hydrocarbon material (adhesive), 2) a method of modifying an adhesive or a pressure sensitive adhesive to enable its adhesion to a material deficient in the adhesive property, and 3) a method of interposing a certain special adhesive layer between such dissimilar layers. To speak more specifically, in the case of 1), the carbon fluoride material is surface treated and the surface treatment includes dry treatments such as flame treatment and corona treatment (see, U.S. Pat. No. 3,133,854, Example 10), and wet treatments such as a combination of alkali solution, liquid ammonia and sodium, and a combination of metal sodium-naphthalene/tetrahydrofuran complex solution (see, U.S. Pat. Nos. 3,133,854 and 4,740,562 and Japanese Unexamined Patent Publication (Kokai) No. 61-7337). Also, a method of modifying the fluoropolymer as a whole (for example, polymer blend or dehydrofluorination (see, U.S. Pat. No. 4,230,768)) to improve the adhesive property to a dissimilar material has been proposed. In the case of 2), Japanese Unexamined Patent Publication (Kokai) No. 3-163182 of Yagi et al. discloses effectiveness of an IPN-style adhesive comprising an acryl polymer and a fluoropolymer, which is obtained by dissolving a fluorine-containing monomer in an acryl monomer and curing the blend; Japanese Unexamined Patent Publication (Kokai) No. 61-31411 of Usami et al. discloses effectiveness of an adhesive obtained by mixing an acryl monomer or oligomer and a fluoropolymer, which are relatively good in the compatibility therebetween; and U.S. Pat. No. 5,482,991 of Kumar et al. discloses effectiveness of an acrylic pressure sensitive adhesive having acrylsiloxane fluoride. With respect to the theoretical research, Paciorek et al., J. Polym. Sci., 45, 405-413 (1960) reports that a fluoropolymer, polyvinyliden fluoride (PVDF) in that paper, reacts with amine after the dehydrofluorination. Schonhorn et al., J. Adhesion Sci. Technol., 4, 277 (1989) reports that PVDF reacts with an epoxy resin containing a diamine curing agent. The case 3) is difficult to clearly distinguish it from the case 2), however, a method of using a mixture of two or more polymers for forming a binder layer to improve the adhesion between dissimilar materials has been reported. European Patent EP-0523644 of Kawashima et al. proposes to improve the adhesive property by combining a fluoropolymer and a polyamide resin. One industrially useful application example is Denka DX film of Denka described in Japanese Unexamined Patent Publication (Kokai) No. 2-28239. This is a film manufactured fundamentally by the melt-coextrusion of two layers different in the mixing ratio. For example, the outer layer comprises a composition of PVDF/PMMA=80/20 and the inner layer comprises a composition of PVDF/PMMA=20/80. At the final stage, a pressure sensitive adhesive is coated on the inner layer with a larger amount of the PMMA (polymethylmethacrylate) component and having a higher polarity.

In the present invention, a most important point is the formation of an adherability-imparting layer, i.e., particularly a primer layer by the irradiation of an electron beam. Here, conventional techniques relating to the formation of a primer layer, which is a most important point of the present invention, are described below.

It is well known that irradiation of an electron beam causes crosslinking of a polymer such as polyethylene and thereby the heat resistance is improved. For example, Modern Fluoropolymers, edited by John Scheirs, John Wiley & Sons, New York (1997) describes this. Furthermore, Maku-uchi et al, J. Poly. Sci. Poly. Chem. Ed. 14, 617-625 (1976) suggests that when PVDF is irradiated with an electron beam, radicals are generated and form a crosslinked structure.

Japanese Unexamined Patent Publication (Kokai) No. 2-209928 of L. Sidney at al. and also their publication at an international meeting (Proceedings of Rad Tech Asia '91, Osaka, Japan (Apr. 15-18, 1991)) suggest that a fluororubber is crosslinked with a polyfunctional acrylate such as trimethylpropane acrylate (TMPTA) upon irradiation of an electric beam and that the TMPTA polymer is grafted to the main chain of a copolymer of vinylidene fluoride and hexafluoropropylene. Japanese Unexamined Patent Publication (Kokai) No. 8-245850 of Hayami et al. states that the thermal properties of THV and the like are improved by a crosslinking agent such as TMPTA or triallylisocyanurate (TAIC) upon irradiation of an electron beam.

On the other hand, the irradiation of an electron beam is also known as a means for crosslinking an adhesive or a pressure sensitive adhesive. U.S. Pat. No. 2,956,904 of Hendriks reports that a rubber-based pressure sensitive adhesive is crosslinked by the irradiation of an electron beam.

U.S. Pat. No. 5,266,400 of Yarusso et al. discloses a method of reducing the acceleration voltage for crosslinking a rubber-based pressure sensitive adhesive on paper (cellulose), polypropylene or polytetrafluoroethylene which are prone to degrade by an electron beam. However, if the acceleration voltage is increased to such a level that an electron beam acts on the substrate, the substrate degrades.

U.S. Pat. No. 5,209,971 of Babu et al. discloses a technique of irradiating an electron beam on a polyolefin-based pressure sensitive adhesive to crosslink the pressure sensitive adhesive, thereby improving the cohesion and heat resistance.

U.S. Pat. No. 4,563,388 of Bonk et al. reports that by irradiating an electron beam on an acryl-based pressure sensitive adhesive coated on a polyolefin-based film material, the adhesive property at the interface is improved. Similarly, Japanese Unexamined Patent Publication (Kokai) No. 63-150330 of Mori et al. reports that when a metal sheet is stacked on a polyolefin film through an acryl-based monomer and an electron beam is irradiated thereon, the adhesion between the polyolefin and the acryl material is improved. U.S. Pat. No. 3,252,880 of Magat et al. shows in Example 8 that when a PTFE (polytetrafluoroethylene) sheet was immersed in an acryl monomer and a γ-ray was applied thereto for 3 days, an acrylonitrile polymer was grafted to the surface of the PTFE sheet and thereby tackyness was generated on the surface. However, the polyacrylonitrile by itself has a Tg of about 100° C. and this is not effective as a pressure sensitive adhesive.

Other than those, reports on the interface adhesion by an electron beam are collectively described below. Japanese Unexamined Patent Publication (Kokai) No. 3-250034 proposes “a method for forming a fluorine-containing polymer layer on a plastic substrate, comprising applying onto a plastic substrate a coating solution obtained by adding an oligomer or polymer to a polyfluorinated group-containing monomer and irradiating thereon an electron beam”. According to this method, from 0.1 to 30 wt % of an oligomer (dissolved or dispersed in an monomer) is added to an electron beam polymerizable monomer having a polyfluoride group, this monomer solution is coated on the surface of a plastic, and an electron beam of from 5 to 200 kGy is irradiated thereon to polymerize and cure the monomer. This invention is characterized in that a thin polymer film comprising a polyfluoride group is formed within a short time on the surface of a plastic and the film is free of a freon solvent and has good adhesive property.

U.S. Pat. Nos. 7,036,039 and 4,861,408 of J. Kelber et al. propose a method for improving the adhesion properties to the substrate by irradiating a low energy electron beam on the surface of a polymer thin film in a high vacuum. More specifically, the polymer surface, for example, the portion very close (50 to 10,000 Å) to the surface of PTFE is treated with a low energy electron beam (from 100 to 10,000 eV) in a high vacuum (10⁻⁸ Torr) to remove fluorine from the carbon-fluorine bond on the substrate surface and convert the bond into a carbon-carbon or carbon-oxygen bond, thereby improving the adhesive properties to various materials. The treated film can be bonded to the brass, copper or steel surface using an ordinary adhesive.

U.S. Pat. No. 4,533,566 of J. Evans et al. proposes to improve the adhesive property by irradiating an electron beam on a polyester film as a substrate for a silicone release liner. This patent relates to the production of a release liner and discloses a method for bonding a silicone thin layer onto a flexible polyester film. More specifically, while allowing a polyester film to move in an atmosphere having an oxygen concentration of 500 ppm or less, preferably 40 ppm or less, the polyester film is exposed to an electron beam of at least 20 kGy, preferably from 20 to 200 kGy, more preferably from 50 to 100 kGy, whereby a thin silicon layer is formed on the film surface.

Toray have filed a series of inventions using a fluororesin film as the substrate. Among these, Japanese Unexamined Patent Publication (Kokai) No. 10-58617 discloses a repairing sheet comprising a fluororesin film having provided on one surface thereof an antifouling layer and on another surface thereof a pressure sensitive adhesive layer. The adhesion between the fluororesin film and the antifouling layer or pressure sensitive adhesive layer is accelerated by a surface treatment of the fluororesin film or undercoating therebetween. When an ultraviolet ray absorbing layer is provided between the fluororesin film and the pressure sensitive adhesive layer and a crosslinking agent is added to the ultraviolet ray absorbing layer, the crosslinking can be attained by heating or exposure to ultraviolet ray or electron beam. However, the adhesion between the fluororesin film and the ultraviolet absorbing layer is accelerated by a surface treatment or undercoating.

Japanese Unexamined Patent publication (Kokai) No. 4-146129 describes a technique of forming a resin coated metal by heat-fusing a fluorine-containing resin film having a printing layer formed of an ink resin composition on the surface of a metal, wherein the ink resin composition comprises an energy line-curable resin. In this technique, the printing layer is merely printed on a part of the fluorine-containing resin film and the fluorine-containing resin film is heat-fused onto the metal film. Furthermore, the fluorine-containing resin film is heat-fused to the metal substrate but not bonded thereto using an adhesive.

Japanese Unexamined Patent Publication (Kokai) No. 5-8353 describes a resin tube suitable for fuel piping of a vehicle, in which a resin tube having a polyamide resin outer layer and a fluororesin inner layer is exposed to radiation to cause crosslinking and thereby introduce a crosslinked structure. This is a double extruded resin product and differs from the adhesive sheet of the present invention.

However, these techniques are disadvantageous in that the adhesion between the fluorine-containing material and the adhesive is not sufficiently high, the process for attaining the adhesion is complicated, or the cost is high. Therefore, a method capable of providing a sufficiently high adhesion between a fluorine-containing material and an adhesive by a more simple method is demanded.

Under these circumstances of conventional techniques, a method for adhering a fluorine-containing material sheet to an adherend with sufficiently high adhesion by a more simple method is demanded.

### SUMMARY

The present invention has been made in order to solve the above-described problems and relates to an adherable fluorine-containing material sheet formed without using a surface treatment or a special adhesive. The present invention also relates to an adhesive fluorine-containing material sheet, a method of adhering a fluorine-containing material sheet, and an adhesion structure, using the adherable fluorine-containing material sheet.

The present inventors have previously disclosed a pressure-sensitive adhesive sheet comprising a substrate which is an electron-beam non-degradable fluorine-containing material sheet, and a pressure sensitive adhesive layer provided on the outer surface of the substrate with or without an intermediate layer therebetween, wherein the fluorine-containing material sheet has a chemical bond with the pressure sensitive adhesive layer or intermediate layer directly contacting with the fluorine-containing material sheet and the chemical bond is formed by the irradiation of an electron beam at least on the fluorine-containing material sheet (Japanese Patent Application No. 11-189081). The present inventors have further studied thereon and verified that an adherable fluorine-containing material sheet where an adherability-imparting layer is provided on the surface of an electron-beam non-degradable fluorine-containing material sheet and a chemical bond formed by irradiating an electron beam at least on the fluorine-material sheet is present between the fluorine-containing material sheet and the adherability-imparting layer, is effective for the adhesion to an adherend using other adhesives including epoxy, hot melt, and acrylic adhesives. The present invention has been accomplished based on this finding.

The adherable fluorine-containing material sheet of the present invention is fundamentally an adherable fluorine-containing material sheet obtained by coating or stacking an adherability-imparting material (e.g., a hot-melt of monomer, syrup, oligomer or polymer, or a polymerization product solution or aqueous dispersion) on a fluorine-containing substrate sheet and irradiating thereon an electron beam to form an adherability-imparting layer capable of adhering using a non-pressure sensitive adhesive. By the irradiation of an electron beam, the adherability-imparting material component is polymerized (crosslinked) and a radical of the molecule of the adherability-imparting material reacts with a radical of the substrate molecule, so that a strong chemical bonding can be formed between two layers which are originally very low in the adhesive property and the substrate sheet can also be crosslinked. The thus-obtained adherability-imparting layer on the fluorine-containing material sheet exhibits good adherability with an ordinary adhesive, accordingly, the fluorine-containing material sheet can be successfully adhered to an adherend using an ordinary adhesive.

The structure of the adherable fluorine-containing material sheet of the present invention is advantageous in that although an adherability-imparting layer is formed on a fluorine-containing material sheet, use of an adhesive layer between two layers or a specific surface treatment of the fluorine-containing material required in conventional techniques can be completely dispensed with. The polymerization (crosslinking) of the adherability-imparting material and the reaction at the interface with a dissimilar material are very important factors, however, the crosslinking of the substrate sheet may be made according to the intensity of the electron beam, for example, the substrate sheet as a whole may be crosslinked or only a portion of the substrate in the vicinity of the interface with the adherability-imparting material may be crosslinked, though some materials undergo degradation of the molecular bonds by an electron beam and prudence is necessary in this point.

According to the present invention, an adhesive fluorine-containing material sheet and an adhering method of a fluorine-containing material sheet, which use the above-described adherable fluorine-containing material sheet, and the resulting adhesion structure are also provided.

(1) An adherable fluorine-containing material sheet comprising an electron-beam non-degradable fluorine-containing material sheet having on the surface thereof an adherability-imparting layer, wherein a chemical bond is present between the fluorine-containing material sheet and the adherability-imparting layer and the chemical bond is formed by the irradiation of an electron beam at least on the fluorine-containing material sheet.

(2) The adherable fluorine-containing material sheet as described in (1), wherein the fluorine-containing material sheet contains a polymer crosslinked by the irradiation of an electron beam.

(3) The adherable fluorine-containing material sheet as described in (1) and (2), wherein the adherability-imparting material contains an adherability-imparting layer crosslinked by the irradiation of an electron beam.

(4) The adherable fluorine-containing material sheet as described in (1) to (3), wherein the fluorine-containing material sheet contains 10 wt % or more of fluorine.

(5) The adherable fluorine-containing material sheet as described in (1) to (4), which is transparent.

(6) The adherable fluorine-containing material sheet as described in (1) to (5), which is a protective film.

(7) An adhesive fluorine-containing material sheet comprising an adherable fluorine-containing material sheet described in (1) to (6) and a non-pressure sensitive adhesive layer formed on the surface of the adherability-imparting layer.

(8) The adhesive fluorine-containing material sheet as described in (7), wherein the adhesive layer is a hot-melt adhesive.

(9) A method for adhering a fluorine-containing material sheet, comprising adhering an adherable fluorine-containing material sheet described in (1) to (6) to an adherend by applying an adhesive onto the surface of the adherable fluorine-containing material sheet and/or the adherend or applying an adhesive therebetween.

(10) The adhering method as described in (9), wherein the adhesive is a hot-melt adhesive.

(11) The adhering method as described in (9), wherein the adhesive is a crosslinking-type adhesive.

(12) An adhesion structure of a fluorine-containing material sheet, wherein an adherable fluorine-containing material sheet described in (1) to (6) is adhering to an adherend through an adhesive.

(13) The adhesion structure as described in (12), wherein the adhesive is a hot-melt adhesive.

(14) The adhesion structure as described in (12), wherein the adhesive is a crosslinking-type adhesive.

### BRIEF DESCRIPTION OF THE FIGURES

FIG. 1 An example of a fluorine-containing material substrate on one side of which an adherability-imparting layer is formed.

FIG. 2 An example of a fluorine-containing material substrate on both sides of which an adherability-imparting layer is formed.

FIG. 3 An example of a fluorine-containing material substrate having on the surface of the substrate a primer layer, on which a hot-melt adhesive layer is formed.

FIG. 4 An example of a fluorine-containing material substrate having on the surface of the substrate a primer layer, on which an elastic layer is formed.

FIG. 5 An example of adhering an adherability-imparted fluorine-containing material sheet of the present invention onto an adherend.

### DETAILED DESCRIPTION

Substrate/Fluorine-Containing Material Sheet

The fluorine material (namely, fluorine-containing material or fluorinated material) for use as the substrate of the adherable fluorine-containing sheet of the present invention may be, for example, a homopolymer or copolymer of carbon fluoride, a blend thereof or a blend with a non-fluorine material.

Examples of useful fluorine-containing monomers include hexafluoropropylene (HFP), tetrafluoroethylene (TFE), vinylidene fluoride (VDF), vinyl fluoride (VF), chlorotrifluoroethylene (CTFE), 2-chloropentafluoropropylene, perfluoroalkyl vinyl ether such as CF₃OCF═CF₂ and CF₃CF₂OCF═CF₂, 1-hydropentafluoropropylene, 2-hydropentafluoropropene, dichlorodifluoroethylene, trifluoroethylene, 1,1-dichlorofluoroethylene, vinyl fluoride and perfluoro-1,3-dioxane (see, U.S. Pat. No. 4,558,142). Examples of useful fluorine-containing diolefin include perfluorodiallyl ether and perfluoro-1,3-butadiene. The fluorine-containing monomer may be copolymerized with a fluorine-free terminal unsaturated monoolefin copolymer such as ethylene or propylene. In the polymer mixture, the fluorine-containing monomer preferably accounts for at least 50 wt % of the entire monomer. The fluorine-containing monomer may be copolymerized with iodine- or bromine-containing curing site monomer to prepare a peroxide curable polymer. Examples of appropriate curing site monomers include a terminal unsaturated monoolefin having from 2 to 4 carbon atoms such as bromodifluoroethylene, bromotrifluoroethylene, iodotrifluoroethylene and 4bromo-3,3,4,4-tetrafluorobutene-1.

A homopolymer or copolymer of these fluorinated carbons or a mixture or crosslinked product thereof with another polymer may also be used.

Examples of the fluoropolymer which can be used include polymers and copolymers such as polyvinylidene fluoride (PVDF), polyvinyl fluoride (PVF), tetrafluoroethylene-perfluoroalkyl vinyl ether copolymer (PFA), tetrafluoroethylene-ethylene copolymer (ETFE), tetrafluoroethylene-ethylene-propylene copolymer, tetrafluoroethylene-ethylene-perfluoroalkyl vinyl ether copolymer, tetrafluoroethylene-ethylene-heptafluoropentene copolymer, tetrafluoroethylene-ethylene-(perfluorobutyl)ethylene copolymer, tetrafluoroethylene-ethylene-hexafluoropropylene copolymer, tetrafluoroethylene-propylene copolymer, tetrafluoroethylene-propylene-vinylidene fluoride copolymer, tetrafluoroethylene-hexafluoropropylene copolymer (FEP), tetrafluoroethylene-hexafluoropropylene-perfluoroalkyl vinyl ether copolymer, tetrafluoroethylene-hexafluoropropylene-vinylidene fluoride copolymer (THV), tetrafluoroethylene-hexafluoropropylene-vinylidene fluoride-tetrafluoroiodopropoxy trifluoroethylene copolymer, tetrafluoroethylene-vinylidene fluoride copolymer, chlorotrifluoroethylene-ethylene copolymer, chlorotrifluoroethylene-vinylidene fluoride copolymer, vinylidene fluoride-hexafluoropropylene copolymer and vinylidene fluoride-trifluoroethylene copolymer. Furthermore, a graft, block or blend polymer of these polymers may also be used and examples thereof include a graft polymer obtained by grafting chlorotrifluoroethylene-vinylidene fluoride copolymer to vinylidene fluoride copolymer, and a block polymer of tetrafluoroethylene-ethylene copolymer with vinylidene fluoride-hexafluoropropylene copolymer.

These polymers are commercially available and examples thereof include the following products.

| | |
|---|---|
| Halar | chlorotrifluoroethylene.ethylene copolymer |
| | (Allied Corp.) |
| KF Polymer | polyvinylidene fluoride (Kureha Kagaku) |
| Teflon FEP | tefrafluoroethylene.hexafluoropropylene |
| | copolymer (E.I. Du Pont) |
| Aclon | chlorotrifluoroethylene.vinylidene |
| | fluoride copolymer (Allied Corp.) |
| KynarFlex 2800 | vinylidene fluoride.hexafluoropropylene |
| | copolymer (Atochem) |
| THV 220G | tetrafluoroethylene.hexafluoropropylene. |
| | vinylidene fluoride copolymer (Dyneon) |
| THV 500G | tetrafluoroethylene.hexafluoropropylene. |
| | vinylidene fluoride copolymer (Dyneon) |
| Aflon COP | tefrafluoroethylene.ethylene-based |
| | copolymer (Asahi Glass) |
| Cefral Soft | vinylidene fluoride-based graft polymer |
| | (Central Glass) |
| Daiel T-530 | hexafluoropropylene.vinylidene fluoride- |
| | based block copolymer (Daikin) |
| HTE X1500 | tetrafluoroethylene.ethylene-based |
| | copolymer (Dyneon) |
| NeoflonEP-610 | tetrafluaroethylene.ethylene-based |
| | copolymer (Daikin) |
| Aflas 150E | tefrafluoroethylene.propylene-based |
| | copolymer (Asahi Glass) |
| Aflas 200 | tetrafluoroethylene.propylene.vinylidene |
| | fluoride copolymer (Asahi Glass) |
| Teflon PFA | tefrafluoroethylene.perfluoropropyl vinyl |
| | ether copolymer (E.I. Du Pont) |
| Tedlar | polyvinyl fluoride (E.I. Du Pont) |
| TFM-1700 | modified polytetrafluoroethylene |

The fluorine-containing material constituting the substrate of the adherable fluorine-containing material sheet of the present invention contains fluorine and, therefore, is excellent in the chemical resistance, heat resistance, mechanical properties and electrical properties. To this purpose, the fluorine must be contained in an amount of at least 10 wt %, preferably 30 wt % or more, more preferably 40 wt % or more of the material. The fluorine may be contained even in an amount of 50 wt % or more and maximally 76 wt %. The substrate of the fluorine-containing material sheet of the present invention is preferably cross-linkable under the irradiation of an electron beam. In the case where the substrate degrades by an electron beam, the acceleration voltage or linear density of the electron beam must be controlled low such that the electron beam does not transmit and degredate not only the irradiated surface area but also the whole bulk, and particular account is also necessary for the irradiation time. For example, polytetrafluoroethylene is a polymer which degrades under irradiation of an electron beam, and not preferred in the present invention. However, a modified polytetrafluoroethylene which is improved in the degradability may be suitably used. Also, an electron-beam degradable material may be used in combination with an electron-beam non-degradable or electron-beam crosslinkable material because the film formed of such a combination is not damaged by the irradiation of an electron beam or under such conditions.

The thickness of the substrate of the adherable fluorine-containing material sheet of the present invention is not particularly limited. In the case of a protective sheet made of polyvinyl chloride, some commercially available products has a thickness of 5 mm or those called as “film” having a thickness of less than hundreds of μm may also be used. In general, the thickness of the substrate is from about 50 to 1,000 μm. The application is not limited and may be a sheet, an adhesive tape, a graphic film, an insulating sheet or the like.

Various additives such as colorants (pigments and dyes), fillers, UV-absorbers may be added to the fluorine-containing material if desired.

Adherability-Imparting Layer

The adherability-imparting material for use in the adherable fluorine-containing material sheet of the present invention is not particularly limited and any may be used as long as it is a material which can form a chemical bond with the fluorine-containing material sheet upon irradiation of an electron beam and at the same time which can adhere by an adhesive.

For example, the component constituting the adherability-imparting material may be a hydrocarbon-based (e.g., acrylate-based, urethane-based) or rubber-based compound. In addition, even polyolefin-based, silicone-based and fluorine-containing compounds which are generally low in the adherability may also be used because an adhesive corresponding thereto can be used. Acrylate as a hydrocarbon-based compound, which is commonly and widely used, is particularly useful, however, the substrate for use in the present invention is a fluorine-containing material having excellent chemical resistance and superior weatherability, therefore, the adherability-imparting material preferably has the same property in some cases and to this purpose, a silicone-based, fluorine-containing or polyolefin-based compound is used. The adherability-imparting material may also be blended with a crosslinking agent, an oligomer or a polymer, or may be formed by the polymerization of a sole adherability-imparting material monomer. The adherability-imparting composition is preferably formed using an electron beam sensitive monomer, oligomer, polymer or crosslinking agent because bonding between the substrate and the pressure sensitive adhesive is accelerated by the irradiation of an electron beam and moreover, the adherability-imparting material is improved in the shear holding force or heat resistance.

The adherability-imparting layer of the adherability-imparted fluorine-containing material sheet may be made of various materials, for example, a primer layer formed of a material having high wettability to an adhesive, an elastic layer formed of a urethane or acrylic rubber material for imparting elasticity to the fluorine-containing material sheet, a monochromatic solid layer, a printing layer having letters and a background or image, or a backing layer (suitably an acryl layer or urethane layer) for ensuring the handleability as a film while reducing the thickness of the fluorine-containing material so as to achieve the low cost, but this is not particularly limited.

The purpose and use of these intermediate layers are briefly described below.

Primer Layer

For example, the surface of the fluorine-containing material substrate may be primed with a material having high wettability to an adhesive. The primer is preferably of acrylates and vinyl compounds that are electron beam curable. For example, monofunctional acrylates including acrylic acid, ethyl acrylate, butyl acrylate, 2-ethylhexyl acrylate, isooctyl acrylate, methoxyethyl acrylate, 2-ethoxyethyl acrylate, 2-hydroxyethyl acrylate, 2-hydroxypropyl acrylate, glycidyl acrylate, isobornyl acrylate, methoxypolyethyleneglycol acrylate, morpholine acrylate, phenoxyethyl acrylate, vinyl acetate and N-vinylpyrrolidone, and polyfunctional acrylates including tryallyl isocyanurate, butanediol diacrylate, pentaerythritol triacrylate, polyethyleneglycol diacrylate and urethane acrylate can be preferably used. These acrylates may be used alone or two or more of them may be combined.

The primer layer is advantageous in that, for example, a very thin primer layer can be cured by an electron beam to cause an interface reaction at a high line speed and taken up to provide an adherability-imparted fluorine-containing sheet having a necessary minimum thickness.

In the present invention, the thickness of the primer layer is not particularly limited and may be, for example, 100 μm or less, suitably 50 μm or less. However, in order to effectively use the fluorine-containing sheet, the primer layer is preferably thinner and in this meaning, the thickness is preferably 30 μm or less, more preferably 10 μm or less.

Elastic Layer

The elastic layer formed of a urethane material, an acrylic rubber material, silicone elastmer material, elastomeric epoxy material, or a foaming material is used as the adherability-imparting layer for the following purposes. The thickness of the fluorine-containing material surface layer having durability can be reduced to realize the low cost while not impairing the handleability as a film. Furthermore, due to the presence of an elastic layer, the curved face conformability (application performance to a curved face) as a laminate film or the stability or durability against abrupt change of temperatures can be improved. In addition, when an elastic layer is present under the substrate, it can serve as a protective film having effects of preventing or reducing scratches generated upon colliding of a pebble or rubbing with a hard material from reaching the material protected, or preventing or reducing the fluorine-containing film itself from flawing.

Printing Layer

Examples of the printing layer include a monochromatic solid layer or a printing layer comprising a letter/an image and a background. For example, at the time of re-coating with an ordinary coating material, the coating is applied after the surface is polished or cleaned with a solvent, however, such a process is not necessary or can be shortened in the case where a fluorine-containing film having high weatherability has a printing layer and coloring or printing is made thereon. Even if the layer is not used for the purpose of coating but used as the protective film, coloring is sometimes required. The coloring also varies depending on the case, for example, coloring for preventing viewing of the background (masking) or translucent coloring may be required, or a logo mark or company name may be printed on the protective film itself.

Backing Layer

For the purpose of ensuring the handleability as a film despite the reduction in the thickness of the fluorine-containing material surface layer having durability so as to curtail the cost, a backing later is provided between the fluorine-containing material surface layer and an adhesive layer. Suitable examples thereof include an acryl layer, a urethane layer and a soft vinyl layer.

The adherability-imparting material may further contain, if desired, various additives in a small amount, such as a pigment, a dye, a plasticizer, a filler, a stabilizer, a UV-absorbent, an antioxidant, a leveling agent, a surface active agent and a process oil.

The adherability-imparting material for use in the present invention may be any of a solventless-type material (e.g., syrup, hot-melt of oligomer or polymer), an organic solvent-type material and a water dispersion-type material (e.g., emulsion, suspension).

The number of these adherability-imparting layers is not limited and for example, a structure such as fluorine-containing material substrate/primer layer, fluorine-containing material substrate/primer layer/elastic layer or fluorine-containing material substrate/primer layer/colored layer (printing layer) may be employed. The present invention is characterized in that since the fluorine-containing material substrate is low in the adhesion to an adherend, the fluorine-containing material substrate is chemically bonded (adhered) to the adherability-imparting layer directly contacting therewith by the irradiation of an electron beam.

The method for coating the adherability-imparting material for use in the present invention on a fluorine-containing material substrate is not particularly limited. A solvent type coating method where the solvent is dried after the coating or a solventless type coating method may be used. As the solvent for use in the solvent type (usually, polymer solution) coating, ethyl acetate, methyl ethyl ketone or a mixed solvent thereof is commonly and widely used.

In the solventless type coating, the adherability-imparting material (monomer, syrup, oligomer, polymer or a mixture thereof) may be directly coated without a solvent or may be coated by a spray or the like. Particularly in the case of a polymer, hot-melt coating may also be used.

In order to render the adherability-imparting material readily wettable to the fluorine-containing material substrate, a fluorine-containing surface active agent, a coupling agent, a fluorocarbon having a functional group such as hydroxyl group, carboxyl group or ether group (for example, perfluoropolyether diol (Dynamar FC-2202, produced by 3M)) may be added to the adherability-imparting composition. Furthermore, the wettability may also be improved by adding a photoinitiator to a monomer which forms the adherability-imparting material, controlling the exposure of the mixture to an ultraviolet ray such that increase in the molecular weight or viscosity is limited to a syrup state, and coating the syrup on a substrate.

Specific examples of the coating method which can be used include bar coating, wire bar coating, four-roll coating, gravure roll coating, spray coating, notch bar coating and die bar coating.

The adherability-imparted fluorine-containing material sheet of the present invention is characterized in that a chemical bond is formed between the fluorine containing material substrate and the adherability-imparting layer by the irradiation of an electron beam. In conventional fluorine-containing sheets, when a fluorine-containing material is used as the substrate, the bonding force between the substrate and the adhesive layer is insufficient because the adhesive has no adhesive property to the fluorine-containing material substrate. Therefore, in order to increase the bonding force between the substrate and the adhesive layer, it has been proposed to subject the substrate surface to a special treatment (e.g., metal sodium treatment, alkali treatment) or interpose a special intermediate bonding layer (a layer formed of a material having adhesive property to a fluorine-containing material and also to an adhesive) therebetween. However, the performance (e.g., adhesive strength, transparency) and the profitability are difficult to attain at the same time. On the other hand, according to the present invention, it has been found that only by the irradiation with an electron beam, a chemical bond is formed between the fluorine-containing material substrate and the adherability-imparting layer and thereby the bonding force therebetween is remarkably increased, as a result, an adherability-imparting sheet comprising a practical fluorine-containing material substrate can be obtained, in which the adherability-imparting layer is sufficiently firmly bonded to the fluorine-containing material substrate. On the surface of a fluorine-containing material substrate irradiated with an electron beam, the bonds of polymers are disconnected to generate radicals and the active sites of the adherability-imparting material are bonded thereto. Since the adherability-imparting material also generates radicals upon irradiation of an electron beam, mutual bonding between the substrate and the adherability-imparting material is facilitated. There arises no problem with respect to the adhesion between the thus-formed adherability-imparting layer and the adhesive layer.

In the present invention, an electron beam must be irradiated at least on interface between the fluorine-containing material substrate and the adherability-imparting layer. The electron beam is preferably irradiated both on the fluorine-containing material substrate and the adherability-imparting layer formed thereon because this is simple and the bonding force is higher. When an electron beam is irradiated on the fluorine-containing material substrate, a crosslinking structure can be introduced into the polymer of the fluorine-containing material substrate.

In the case where a covalent bond is formed between the fluorine-containing material substrate and the adherability-imparting layer by the irradiation of an electron beam, the bonding is different from the structure obtained when a chemical bond is formed by other methods such as metal sodium treatment or alkali treatment. The adherability-imparted fluorine-containing sheet of the present invention is characterized by having such a structure derived from an electron beam irradiation.

As another characteristic feature of the adherability-imparted fluorine-containing sheet of the present invention, when a chemical bond is formed between the fluorine containing material substrate and the adherability-imparting layer by the irradiation of an electron beam, the surface of the fluorine-containing material substrate is not subjected to a surface treatment such as metal sodium treatment or corona discharging. The surface of a fluorine-containing material substrate subjected to a surface treatment such as metal sodium treatment has traces of the surface treatment such as metal sodium treatment, however, the present invention is free of such traces. For example, in the metal sodium treatment, the surface of the fluorine-containing material substrate is discolored to brown or black. When the substrate is discolored, the fluorine-containing material sheet cannot be transparent.

According to the present invention, at the time when an adherability-imparting material is coated on the surface of a fluorine-containing material substrate and bonded thereto by the irradiation of an electron beam, polymerization or cross-linking of the adherability-imparting material can simultaneously proceed by the irradiation. Therefore, the present invention is advantageous as compared with conventional techniques in that a special process for forming a bond between the fluorine-containing material substrate and the adherability-imparting layer needs not be additionally provided. Furthermore, since the fluorine-containing substrate can also be crosslinked by the irradiation of an electron beam, the chemical resistance and heat resistance of the substrate can be further improved.

The electron beam may be irradiated either from the adherability-imparting layer side or from the substrate side.

The conditions for the irradiation of an electron beam may be sufficient if radicals are generated on the substrate surface in contact with the adherability-imparting layer. The conditions vary depending on the kind and thickness of the fluorine-containing material substrate or the adherability-imparting material, however, it is suitably 10 keV or more, 30 kGy or more. More preferably it is from 50 to 200 keV, 30 to 1,000 kGy.

According to the present invention, it has been found that a chemical bonding can also be formed between the fluorine-containing material substrate and the adherability-imparting layer by irradiating an electron beam on the substrate to generate radicals on the substrate surface and immediately thereafter coating an adherability-imparting layer on the substrate surface. However, as compared with the case where an adherability-imparting layer is formed on the substrate surface and then an electron beam is irradiated thereon, the intensity of the chemical bond formed is slightly reduced. Although it is theoretically most preferred to maintain the vacuum between the irradiation of an electron beam on the substrate surface and the coating of the adherability-imparting layer so that the radicals on the substrate surface can be prevented from reaction with oxygen radicals, an interface adhesive strength sufficiently tolerable in practice can be attained even by irradiating EB, immediately followed by coating an acrylate syrup thereon in an ordinary atmosphere (oxygen concentration: about 20%) and curing it by an ultraviolet ray.

The intensity of the chemical bond formed between the fluorine-containing material substrate and the adherability-imparting layer according to the present invention can be evaluated by an adhesion/peeling test of the adherability-imparted fluorine-containing material sheet obtained. A specific method is described later in the Examples.

According to the present invention, it has been verified from the results in the adhesion/peeling test of the adherable fluorine-containing material sheet where a chemical bond is formed between the fluorine-containing material substrate and the adherability-imparting layer, a strong chemical bond is formed between the fluorine-containing material substrate and the adherability-imparting layer.

Adhering Method

In the adherability-imparted fluorine-containing material sheet of the present invention, an adherability-imparting layer is formed on the surface of a fluorine-containing material substrate having poor adherability, therefore, the fluorine-containing material sheet can be easily adhered to the surface of an adherend in the same manner as in the adhering method using an ordinary non-pressure sensitive adhesive but without using a special method.

Namely, an adhesive is applied to either one or both of the surface of the adherability-imparting layer of the adherability-imparted fluorine-containing material sheet and the surface of an adherend or between the adherability-imparting layer of the adherability-imparted fluorine-containing material sheet and an adherend, and then the fluorine-containing material sheet and the adherend are tightly contacted or attached by pressure, whereby the fluorine-containing material sheet can be adhered to the adherend.

Examples of the non-pressure sensitive adhesive for use in such a method include the followings.

Hot-Melt Adhesive

The hot-melt adhesive means an adhesive mainly comprising a thermoplastic resin and having a solid content of 100%, which is solid at room temperature. The hot-melt adhesive is usually heat-melted in a coater called an applicator, and coated in the melted state on an adherend. After the attachment by pressure, when the melted resin is cooled, the adhesion is completed. In the case of the adherable fluorine-containing material sheet of the present invention, a hot-melt adhesive may be temporarily adhered by previously fusing or coating it on the surface of the adherability-imparting layer to prepare an adhesive fluorine-containing material sheet which is used for the adhesion.

The hot-melt adhesive does not contain water or a solvent and can dispense with a drying time and a drying apparatus, so that the adhesion can be completed by the attachment under pressure for a short period of time after the application of the adhesive. Furthermore, unlike the pressure-sensitive adhesive sheet, the hot-melt adhesive does not exhibit adhesive property before the heat-melting, therefore, the storage is easy and the storage stability is excellent.

With respect to the component constituting the hot-melt adhesive, a thermoplastic resin, a tackifier or a wax is used and if desired, an antioxidant, a filler and the like may be blended therewith. Representative examples of the thermoplastic resin (base polymer) include ethylene-vinyl acetate copolymer (EVA), polyethylene, atactic polypropylene (APP), ethylene-ethyl acrylate copolymer (EEA), polyamide and polyester. Examples of the tackifier which can be used include rosin, rosin derivatives, pinene-type resin and hydrocarbon resin (petroleum resin). The wax is used for lowering the melt viscosity of the adhesive or controlling the physical properties such as open time, softening point, hardness, hot tackyness and blocking.

The application method (use method) of the hot-melt adhesive slightly varies mainly depending on the shape thereof, namely between the bulk hot melt and the film hot melt. In the case of the bulk hot melt, a hot-melt adhesive formed into a pellet or a bar is heated and liquefied in an applicator having various sizes and coated on a material to be adhered (adherend) like a dot or line or coated by a spray like a spider web, and another adherend is superposed thereon before the hot-melt adhesive is cooled to set. The hot-melt adhesive is usually cooled to set within a few minutes, therefore, at that time, a sufficiently high strength can be obtained. In the case of the film hot-melt adhesive, the adhesion is not attained by the heat-melting but a hot-melt adhesive previously formed into a film is placed between two (or two sheets of) adherends which are intended to adhere, and these are passed through a hot press or heating rollers to liquefy the hot melt between the adherends and thereby complete the adhesion. This method is effective in the case where the material to be adhered is in the film form or the entire surface of an adherend is intended to adhere. In this method, the adherend itself is heated, therefore, the method must be employed by taking account of the relationship between the heat resistance of the adherend and the temperature where the hot melt is liquefied. In particular, for adherends having low heat resistance or for uses where the dimensional change by the heat is inhibited, an adhesive capable of being liquefied at a low temperature, such as low melt series (produced by 3M), is effective. The hot-melt adhesive also include rubber-based hot melts and for the main component thereof, a styrene-based elastomer such as SIS (styrene-isoprene-styrene copolymer), SBS (styrene-butadiene-styrene copolymer) and SEBS (styrene-ethylene-butene-styrene copolymer) or an olefin-based elastomer is usually used in many cases. Also in this rubber-based hot melt, a tackifier or a wax is mixed. Further, the hot-melt adhesive may be a moisture curable hot melt (predominantly a urethane-based hot melt). This is different from the ordinary hot-melt adhesive in the point that the adhesive strength increases with the elapse of time, namely, as the curing reaction proceeds due to moisture, but the use method thereof is fundamentally the same as the ordinary hot-melt adhesive.

These hot-melt adhesives can be suitably used for the uses intended to improve the antifouling property on the surface, improve the resistance against chemicals, improve the weatherability or reduce the friction coefficient.

Curable Adhesive

The curable adhesive includes a thermosetting adhesive, an ambient temperature-curable adhesive and an UV-curable adhesive.

(1) Epoxy Resin Adhesive

The commonly used curable adhesive is an epoxy resin-type adhesive. The epoxy resin-type adhesive is roughly classified into a thermosetting adhesive and an ambient temperature-curable adhesive. The thermosetting adhesive is heat-cured at a high temperature (usually 80° C. or more), therefore, the crosslinking structure is liable to be dense and the cured product is generally favored with high strength, superior heat resistance and excellent resistance against chemicals. The ambient temperature-curable adhesive is an adhesive used by mixing an epoxy-based main agent with a curing agent such as amine or mercaptan and thereafter curing it at an ambient temperature. This is advantageous in that a heating apparatus is not necessary and the curing can be performed outdoors. Even in the case of the ambient temperature-curable adhesive, when it is heat-cured, the curing may be completed within a short time or the curing reaction may be accelerated.

(2) Other Curable Resin Adhesive

When an adhesive curable with ultraviolet ray, visible ray or electron beam is used, the curing may be attained within a short time in seconds. The main component is generally an acryl-type, silicone-type or epoxy-type adhesive. In particular, the acryl-type adhesive is roughly classified into, other than the photocurable type, an anaerobic polymerization type in which the reaction starts under insulation of an air, a primer type, a two-liquid mixing type and a microcapsule type, and these can also be used.

Rubber-Based Adhesive

The rubber-based adhesive include a hot-melt-type adhesive (described above) and an aerosol-type adhesive (described later). Generally, an adhesive obtained by dissolving a rubber in a solvent is used in many cases. Examples of the rubber include various rubbers such as natural rubber, SBR (styrene-butadiene rubber), NBR (nitrile rubber), chloroprene rubber, butyl rubber, polysulfide-based synthetic rubber, acrylic rubber, urethane rubber and silicon rubber. In addition, derivatives (e.g., chloride rubber, sulfide rubber, maleic acid rubber) and graft copolymer or block copolymer rubbers may be used. The rubber is widely used because the rubber in general well adheres to many materials and the initial adhesive strength thereof is large. In many cases, the rubber is dissolved in an organic solvent and the resulting rubber solution is coated or sprayed on an adherend. The rubber is sometimes used as a water dispersion-type latex and this is described later. To the rubber-based adhesive, a tackifier, a vulcanizing agent and an antioxidant are usually added.

Aqueous Adhesive

The aqueous adhesive, in the present invention, a water dispersion-type adhesive, includes a long known natural rubber-based latex. In recent years, a synthetic rubber-based latex is used in many cases. Examples of the synthetic rubber-based latex which is predominantly used include SBR (styrene-butadiene rubber), NBR (nitrile rubber), CR (chloroprene rubber), IR (isoprene rubber) and acrylic rubber. The aqueous adhesive is advantageous in that the working environment can be improved (free of dangers of fire or poisoning) because an organic solvent is not contained, the working process is easy because the medium is water, and the adhesive can be used in a higher concentration as compared with the solvent-type adhesive because this is a dispersion type adhesive. To this aqueous adhesive, a crosslinking agent, a crosslinking accelerator, a tackifier and a thickener are generally added in many cases.

Aerosol Adhesive

The aerosol-type adhesive is generally prepared by dissolving or dispersing a rubber-based adhesive, namely rubber, in a solution and filling it into a spray can together with a propellant. In some cases, the adhesive is jetted out like spraying by a hand pump without using a propellant. The composition itself of the adhesive is the same as that of the solvent-type adhesive or the aqueous adhesive.

Others

An instantaneous adhesive (cyanoacrylate-base) can also be very suitably used.

(Adhesive Fluorine-Containing Material Sheet)

In the adhering method using the adherable fluorine-containing material sheet of the present invention, as described above, the fluorine-containing material sheet is adhered to an adherend using an adhesive such as a hot-melt adhesive and this may be performed not only by a method of applying the adhesive to the fluorine-containing material sheet first at the adhering but also by a method of temporarily adhering an adhesive layer such as a hot-melt adhesive by previously fusing or coating it on the surface of the adherability-imparting layer of the adherable fluorine-containing material sheet of the present invention to prepare an adhesive fluorine-containing material sheet, applying the prepared adhesive fluorine-containing material sheet to an adherend and heating these at an appropriate stage to complete the adhesion.

As such, the present invention also include an adhesive fluorine-containing material sheet obtained by temporarily adhering an adhesive to the surface of the adherability-imparting layer of the adherable fluorine-containing material sheet.

Examples of the adhesive which can be suitable used for the adhesive fluorine-containing material sheet include, in addition to a hot-melt adhesive, an acryl-type adhesive, a rubber-based adhesive, an emulsion-type adhesive and an instantaneous adhesive.

However, a pressure-sensitive adhesive is disclosed in Japanese Patent Application No. 11-189081 and excluded from the present invention.

Examples of the adhesive which can be used include those described above in connection with the adhering method and an appropriate adhesive may be selected by taking account of the adhesive property between the adherability-imparting layer formed on the fluorine-containing material sheet and the adhesive, the adhesive property between the adhesive and an adherend (e.g., metal, glass, organic material), the properties required in the final usage (e.g., chemical resistance, weatherability, antifouling property), and the working conditions.

A constitution example, an adhering method and an adhesion structure of the adherability-imparted fluorine-containing material sheet and the adhesive fluorine-containing material sheet of the present invention are described below by referring to the drawings attached hereto.

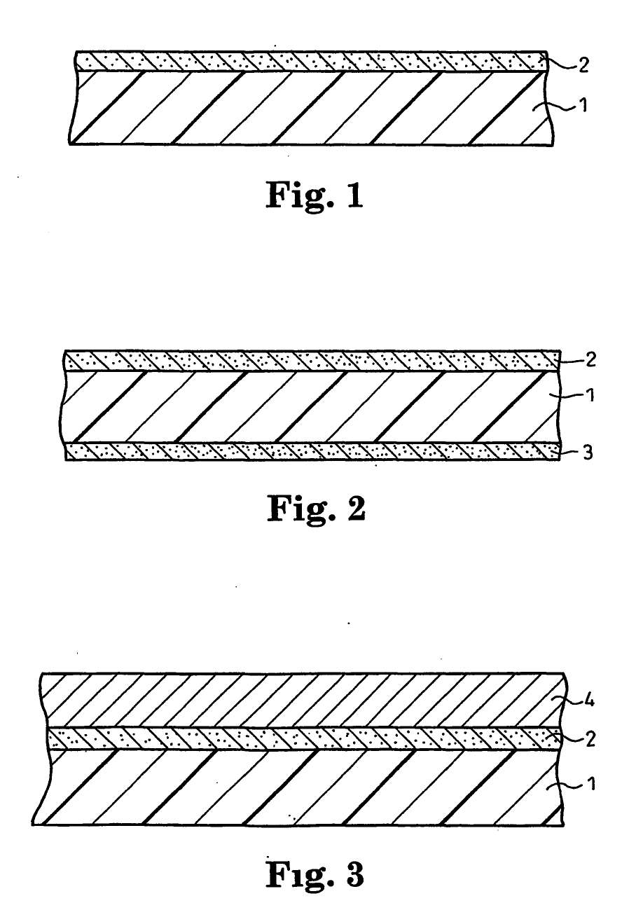

FIG. 1 shows an example where an adherability-imparting layer 2 is formed on a fluorine-containing material substrate 1.

FIG. 2 shows an example where adherability-imparting layers 2 and 3 are formed on both surfaces of a fluorine-containing material substrate 1. In the adherability-imparted fluorine-containing material sheet of the present invention, the adherability-imparting layer may be provided on both surfaces of the fluorine-containing material substrate.

FIG. 3 shows an example where a primer layer 4 is formed as the adherability-imparting layer on the surface of a fluorine-containing material substrate 1 and a hot-melt adhesive layer 5 is temporarily adhered thereon (an example of the adhesive fluorine-containing material sheet).

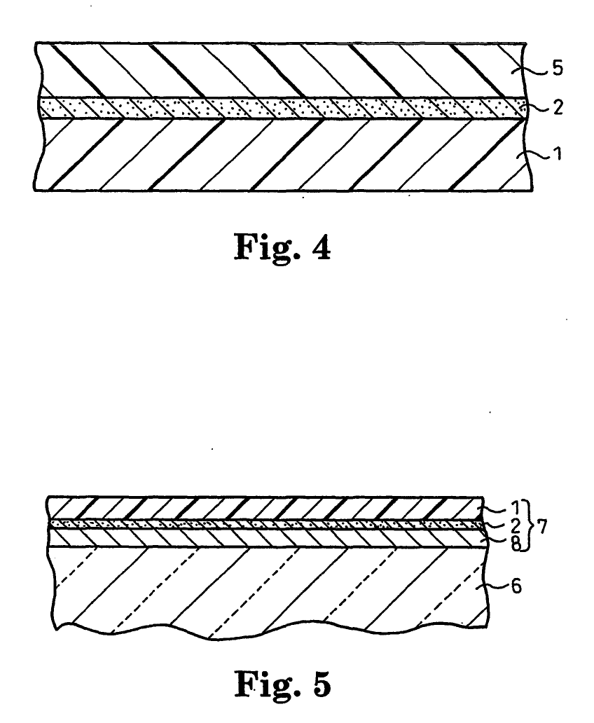

FIG. 4 shows an example where a primer layer 4 is formed on a fluorine-containing material substrate 1 and a layer 6 such as an elastic layer, a printing layer or a backing layer is formed thereon. In the example of FIG. 4, the printing layer or backing layer 6 maybe formed directly on the fluorine-containing material substrate 1 without forming the primer layer 4.

In these examples, the adherability-imparted fluorine-containing material sheet of the present invention is characterized in that the bonding between the fluorine-containing material substrate 1 and the layer directly contacting therewith is chemical bonding caused by the irradiation of an electron beam. Other layers may also be chemically bonded by the irradiation of an electron beam.

FIG. 5 shows an example where adhering to an adherend is performed using the adherability-imparted fluorine-containing material sheet of the present invention. The adherend 6 is an example of a glass or plastic plate in which surface contamination should be avoided. The adherability-imparted fluorine-containing material sheet 7 on which a hot-melt adhesive 8 is coated in an applicator (not shown) is attached by pressure to the adherend while the hot-melt adhesive 8 is in the melted state, then, the hot-melt adhesive 8 is cooled within a few seconds, thereby completing the adhesion.

### EXAMPLES

The present invention is described below by referring to the Examples, however, the present invention is by no means limited thereto.

Substrate Film

Carbon fluoride substrate films used in Examples and Comparative Examples are shown in Table 1 below.

TABLE 1
Substrate film

| | Trade Name or | | |
|---|---|---|---|
| Abbreviation | Composition | Thickness, μm | Seller |
| THV500 | TFE-HFP-VDF terpolymer | 200 | Dyneon LLC |
| PVDF | Kynar 740 | 260 | Atochem |
| ETFE | ET 6235J ethylene-TFE | 120 | Dyneon LLC |
| | copolymer | | |
| m-PTFE | TFM-1700, modified PTFE | 100 | Dyneon LLC |

In Table 1, THV is a TFE-HFP-VDF terpolymer (TFE is tetrafluoroethylene, HFP is hexafluoropropylene and VDF is vinylidene fluoride), PVDF is polyvinylidene fluoride, ETFE is an ethylene-TFE copolymer and m-PTFE is a modified polytetrafluoroethylene;

PVDF and E-TFE were molded by heat pressing to manufacture films, PTFE was a commercially available film, and m-PTFE was subjected to ram molding and then skiving to prepare a film;

THV500 film was prepared from a T-die extruder,

Irradiation of Electron Beam

In the following Examples, the electron beam was irradiated from the release sheet side in a nitrogen atmosphere (oxygen concentration: about 50 ppm) at normal temperature under the conditions such that the acceleration voltage was from 150 to 250 kV, the dose was from 50 to 200 kGy, and the line speed was from 2 to 5 m/min. The apparatus used was System 7824 manufactured by Energy Science, Inc.

Adhesion of Fluorine-Containing Material Sheet and Adherability-Imparting Layer

In the following Examples, an adherability-imparting layer originally having low adhesive property was adhered to a fluorine film (THV film or PVDF film) by the irradiation of an electron beam. For example, the adherability-imparting layer was an elastic material such as urethane and acrylate elastomer, a blend of isobornyl acrylate or butyl acrylate and an acrylic acid, which is polymerized to form a primer layer or an anchor layer, or a coating material or ink. In some cases, coloring is applied on the layer (elastic material primer layer or coating material), therefore, this possibility was examined here. Also, it is known that when an adherability-imparting layer is formed, the adhesion can be finally attained using an adhesive and in this connection, the adhesive strength was tested as described later.

Adherend (Fluorine-Containing Material Sheet)

THV500 film (manufactured using a T-die extruder, thickness: about 200 μm) or PVDF film (commercially available film, thickness: about 260 μm).

Adherability-Imparting Layer Formed on Fluorine-Containing Material Sheet

(a) Primer Layer

Three kinds of materials were used, namely, isobornyl acrylate (IBA, IB-XA, produced by Kyoei-Sha Yushi Kagaku Kogyo K. K.), t-butyl acrylate (TBA, produced by Osaka Yuki Kagaku Kogyo K. K.) and a blend of butyl acrylate (BA, produced by Wako Junyaku Kogyo K. K.) and acrylic acid (AA, produced by Wako Junyaku Kogyo K. K.) (blending ratio: BA/AA=30/70). In any case, 0.01% (for electron beam curing of Examples) or 0.5% (for ultraviolet ray curing of Comparative Examples) of a photoinitiator (Darocur 1173, produced by Chiba Specialty Chemicals K. K.) were added and after increasing the viscosity by irradiating an ultraviolet ray, each material was coated. The coating thickness was controlled to about 30 μm. After the coating, the surface was protected by a transparent silicone release liner and then curing with an electron beam (Examples) or an ultraviolet ray (Comparative Examples) was performed. The compositions are shown in Table 2.

(b) Elastic Material

Urethane acrylate (M-1310, produced by Toa-Gosei Kagaku K. K., crosslinked type because this is bifunctional) as a urethane-based material, and 2-methoxyethyl acrylate (produced by Wako Junyaku Kogyo K. K.) as an acrylic rubber-type material were used. Since the 2-methoxyethyl acrylate is monofunctional, in a case, a crosslinking agent was also added thereto.

The urethane acrylate as having a high viscosity at an ambient temperature was hot-melt coated on a fluorine film at about 80° C. to a thickness of about 200 μm. A solvent diluent or a surface active agent may also be added. The methoxyethyl acrylate as having a low viscosity at an ambient temperature was increased in the viscosity up to the level of ensuring good coating by adding a slight amount (0.01% or 0.5%) of a photoinitiator and then irradiating an ultraviolet ray. If desired, a surface active agent may be added. Thereafter, in some Examples, a crosslinking agent (KAYARAD HDDA, produced by Nippon Kayaku K. K.) was added. The coating thickness was controlled to about 200 μm. After the coating, the surface was protected by a transparent silicone release liner and then an electron beam (examples) or an ultraviolet ray (Comparative Examples) was irradiated to cure the layer material. The compositions are shown in Table 2.

(c) Coating Material or Ink

Using an ultraviolet ray-curable ink (UV FIL ink No. 190, produced by Teikoku Ink Seizo K. K.), a line in a width of about 300 μm was drawn and cured by an electron beam (Examples) or an ultraviolet ray (Comparative Examples).

Conditions for Irradiation of Electron Beam or Ultraviolet Ray

The irradiation of an electron beam was performed under the conditions such that the acceleration voltage was 250 kV and the linear density was 200 kGy. The irradiation of an ultraviolet ray was performed at an exposure of 1,500 mJ/cm².

TABLE 2
Combination of Composition and Fluorine Film

| | Composition | Fluorine film |
|---|---|---|
| Example 1 | IBA + 0.01% of photoinitiator | THV |
| Comparative Example 1 | IBA + 0.5% of photoinitiator | THV |
| Example 2 | IBA + 0.01% of photoinitiator | PVDF |
| Comparative Example 2 | IBA + 0.5% of photoinitiator | PVDE |
| Example 3 | TBA + 0.01% of photoinitiator | THV |
| Comparative Example 3 | TBA + 0.5% of photoinitiator | THV |
| Example 4 | TBA + 0.01% of photoinitiator | PVDF |
| Comparative Example 4 | TBA + 0.5% of photoinitiator | PVDF |
| Example 5 | BA/AA = 30/70 + 0.01% of photoinitiator | THV |
| Comparative Example 5 | BA/AA = 30/70 + 0.5% of photoinitiator | THV |
| Example 6 | BA/AA = 30/70 + 0.01% of photoinitiator | PVDF |
| Comparative Example 6 | BA/AA = 30/70 + 0.5% of photoinitiator | PVDF |
| Example 7 | M-1310 | THV |
| Comparative Example 7 | M-1310 + 0.5% of photoinitiator | THV |
| Example 8 | M-1310 | PVDF |
| Comparative Example 8 | M-1310 + 0.5% of photoinitiator | PVDF |
| Example 9 | MEA + 0.01% of photoinitiator | THV |
| Comparative Example 9 | MEA + 0.5% of photoinitiator | THV |
| Example 10 | MEA + 0.01% of photoinitiator | PVDF |
| Comparative Example 10 | MEA + 0.5% of photoinitiator | PVDF |
| Example 11 | MEA + 0.01% of photoinitiator + 0.5% of crosslinking agent | THV |
| Comparative Example 11 | MBA + 0.5% of photoinitiator + 0.5% of crosslinking agent | THV |
| Example 12 | MEA + 0.01% of photoinitiator + 0.5% of crosslinking agent | PVDF |
| Comparative Example 12 | MBA + 0.5% of photoinitiator + 0.5% of crosslinking agent | PVDF |
| Example 13 | MBA +0.01% of photoinitiator + 1% of crosslinking agent | THV |
| Comparative Example 13 | MEA + 0.5% of photoinitiator + 1% of crosslinking agent | THV |
| Example 14 | MEA + 0.01% of photoinitiator + 1% of crosslinking agent | PVDF |
| Comparative Example 14 | MBA + 0.5% of photoinitiator + 1% of crosslinking agent | PVDF |
| Example 15 | UV FIL 190 | THV |
| Comparative Example 15 | UV FIL 190 | THV |
| Example 16 | UV FIL 190 | PVDF |
| Comparative Example 16 | UV FIL 190 | PVDF |

Results

After the curing by an electron beam or ultraviolet ray, the protective liner was removed (except for Examples 15 and 16 and Comparative Examples 15 and 16). Thereafter, all samples were immersed in methyl ethyl ketone at room temperature for 24 hours and then the adhesive property between layers and the solvent resistance were examined. In the samples of Examples 1 to 16, peeling did not occur between the fluorine film and the elastic layer, primer layer or coating material layer, and the layer did not dissolve and disappear in the solvent, thus no particular change was observed. On the other hand, in Comparative Examples, peeling between layers or dissolution in the solvent occurred. The results obtained are shown in Table 3 below.

TABLE 3
Change after Immersion in Solvent

| | |
|---|---|
| Example 1 | No particular change |
| Comparative Example 1 | Acrylate layer was dissolved in the solvent. |
| Example 2 | No particular change |
| Comparative Example 2 | Acrylate layer was dissolved in the solvent. |
| Example 3 | No particular change |
| Comparative Example 3 | Acrylate layer was dissolved in the solvent. |
| Example 4 | No particular change |
| Comparative Example 4 | Acrylate layer was dissolved in the solvent. |
| Example 5 | No particular change |
| Comparative Example 5 | Acrylate layer was dissolved in the solvent. |
| Example 6 | No particular change |
| Comparative Example 6 | Acrylate layer was dissolved in the solvent. |
| Example 7 | No particular change |
| Comparative Example 7 | Urethane layer was peeled off and suspended in the solvent. |
| Example 8 | No particular change |
| Comparative Example 8 | Urethane layer was peeled off and suspended in the solvent. |
| Example 9 | No particular change |
| Comparative Example 9 | Acrylic rubber layer was dissolved in the solvent. |
| Example 10 | No particular change |
| Comparative Example 10 | Acrylic rubber layer was dissolved in the solvent. |
| Example 11 | No particular change |
| Comparative Example 11 | Acrylic rubber layer was peeled off and suspended in the solvent. |
| Example 12 | No particular change |
| Comparative Example 12 | Acrylic rubber layer was peeled off and suspended in the solvent. |
| Example 13 | No particular change |
| Comparative Example 13 | Acrylic rubber layer was peeled off and suspended in the solvent. |
| Example 14 | No particular change |
| Comparative Example 14 | Acrylic rubber layer was peeled off and suspended in the solvent. |
| Example 15 | No particular change |
| Comparative Example 15 | Coating material was dissolved in the solvent. |
| Example 16 | No particular change |
| Comparative Example 16 | Coating material was dissolved in the solvent. |

Formation of Multi-Layer Structure

It is known that when adherability-imparting layers as described above are formed and sticked on a fluorine-containing material, the adherability-imparting layers themselves can be finally adhered by an adhesive. Accordingly, here, the results of adhesion test using of TFM-1700 (modified polytetrafluoroethylene) which is a particularly poorly adherable fluorine-containing material film, and ETFE (ethylene/tetrafluoroethylene/vinylidenefluoride copolymer) and PVDF (polyvinylidenefluoride) as typical examples of the fluorine-containing material are shown. The structure of the tested sheet is a four layer structure of fluorine-containing material film/electron beam curable material (primer layer)/adhesive/adherend. The adhesives used were an epoxy resin adhesive, ultraviolet ray curable adhesive and hot melt adhesive. In all the cases, the adhesion of the fluorine-containing material film was significantly improved by the present invention.

(1) A syrup of a prepolymer of BA and AA in various formulations was coated as the adherability-imparting layer to various thicknesses. From the primer layer side, an electron beam was applied at various doses to polymerize the primer layer and bond the primer layer and the substrate.

The thus-treated sheets and untreated sheets for comparison each was adhered to a glass plate using an epoxy resin adhesive (Scotch-Weld DP-100 Plus clear, manufactured by 3M). The thickness of the adhesive was about 30 μm.

After the adhesion, the 180° peel strength of the fluorine-containing material sheet was measured, in which the peel speed was, 30 mm/min.

The results are shown in Table 4.

TABLE 4
Results of Adhesion Test Using Epoxy Resin Adhesive

| | | | | | Peel |
|---|---|---|---|---|---|
| | | | | Primer | Strength |
| | | Dose | | Thickness | (N/ |
| | | (kGy) | Formulation | (μm) | 25 mm) |
| Example 17 | ETFE | 100 | BA/AA (90/10) | 5 | 14.5 |
| Comparative | ETFE | none | — | — | 0.4 |
| Example 17 | | | | | |
| Example 18 | PVDF | 100 | BA/AA (90/10) | 5 | 28 |
| Comparative | PVFD | none | — | — | 5-25 |
| Example 18 | | | | | |
| Example 19 | TFM-1700 | 100 | BA/AA (75/25) | 70 | 14.5 |
| Example 20 | TFM-1700 | 100 | BA/AA (75/25) | 5 | 10.5 |
| Example 21 | TFM-1700 | 150 | BA/AA (75/25) | 5 | 9.0 |
| Example 22 | TFM-1700 | 150 | BA/AA (75/25) | 5 | 8.2 |
| Comparative | TFM-1700 | none | — | — | 3.2 |
| Example 19 | | | | | |

(2) The adhesion was performed in the same manner as above except for using an UV-curable adhesive (Scotch-Grip LC-2101, manufactured by 3M) in place of the epoxy resin adhesive, and the peel strength was measured in the same manner. The thickness of the adhesive was about 30 μm. The formulation of the primer layer was IOA/AA (90/10), the thickness of the coating was about 5 μm, and the electron beam intensity was 100 kGy.

The results are summarized in Table 5.

TABLE 5
Results of Adhesion Test Using UV Curable Adhesive

| | | | | | Peel |
|---|---|---|---|---|---|
| | | | | Primer | Strength |
| | | Dose | | Thickness | (N/ |
| | | (kGy) | Formulation | (μm) | 25 mm) |
| Example 23 | ETFE | 100 | BA/AA (90/10) | 5 | 2.3 |
| Comparative | ETFE | none | — | — | 0.1 |
| Example 20 | | | | | |
| Example 24 | TFM-1700 | 100 | BA/AA (90/10) | 5 | 9.1 |
| Comparative | TFM-1700 | none | — | — | 0.35 |
| Example 21 | | | | | |

(3) The above was repeated but a hot melt adhesive (Three-Bond Film 668, manufactured by 3M was used in place of the epoxy resin adhesive. An adhesive in the sheet form with a thickness of about 100 μm was pressed at 160° C. for 10 seconds to a thickness of about 90 μm after the pressing.

The results of the peel strength are summarized in Table 6.

TABLE 6
Results of Adhesion Test Using Hot Melt Adhesive

| | | | | | Peel |
|---|---|---|---|---|---|
| | | | | Primer | Strength |
| | | Dose | | Thickness | (N/ |
| | | (kGy) | Formulation | (μm) | 25 mm) |
| Example 25 | TFM-1700 | 100 | BA/AA (75/25) | 5 | 9.5 |
| Comparative | TFM-1700 | none | — | — | 1.5 |
| Example 22 | | | | | |

What is claimed is:

1. An adherable fluorine-containing material sheet comprising an electron-beam non-degradable fluorine-containing material sheet having on the surface thereof an adherability-imparting layer, wherein a chemical bond is present between the fluorine-containing material sheet and the adherability-imparting layer and the chemical bond is formed by the irradiation of an electron beam at least on the fluorine-containing material sheet.

2. The adherable fluorine-containing material sheet of claim 1 wherein said fluorine-containing material sheet contains a polymer crosslinked by the irradiation of an electron beam.

3. The adherable fluorine-containing material sheet of claim 1 or 2 wherein said adherability-imparting layer contains an adherability-imparting material crosslinked by the irradiation of an electron beam.

4. The adherable fluorine-containing material sheet of claim 1, 2, or 3 wherein said fluorine-containing material sheet contains 10 wt % or more of fluorine.

5. The adherable fluorine-containing material sheet of any one of claims 1 to 4, which is transparent.

6. The adherable fluorine-containing material sheet of any one of claims 1 to 5, which is a protective film.

7. An adhesive fluorine-containing material sheet comprising an adherable fluorine-containing material sheet described in any one of claims 1 to 7 and a non-pressure sensitive adhesive layer formed on the surface of said adherability-imparting layer.

8. The adhesive fluorine-containing material sheet of claim 7, wherein said adhesive layer is a hot-melt adhesive.

9. A method for adhering a fluorine-containing material sheet, comprising adhering an adherable fluorine-containing material sheet described in any one of claims 1 to 6 to an adherend by applying an adhesive onto the surface of said adherable fluorine-containing material sheet and/or the surface of an adherend or by applying an adhesive therebetween.

10. The adhering method of claim 9, wherein said adhesive is a hot-melt adhesive.

11. The adhering method of claim 9, wherein said adhesive is a crosslinking-type adhesive.

12. An adhesion structure of a fluorine-containing material sheet, wherein an adherable fluorine-containing material sheet described in any one of claims 1 to 6 is adhering to an adherend through an adhesive.

13. The adhesion structure of claim 12, wherein said adhesive is a hot-melt adhesive.

14. The adhesion structure of claim 12, wherein said adhesive is a crosslinking-type adhesive.
